(19) United States
(12) Patent Application Publication
(10) Pub. No.: US 2012/0045986 A1
(43) Pub. Date: Feb. 23, 2012

(54) WIRELESS COMMUNICATION SYSTEM, RELAY STATION, RECEIVER STATION, AND WIRELESS COMMUNICATION METHOD

(75) Inventor: Daisuke JITSUKAWA, Kawasaki (JP)

(73) Assignee: FUJITSU LIMITED, Kawasaki-shi (JP)

(21) Appl. No.: 13/211,464

(22) Filed: Aug. 17, 2011

(30) Foreign Application Priority Data
Aug. 19, 2010 (JP) 2010-184391

(51) Int. Cl. H04B 7/14

(52) U.S. Cl. 455/7

(57) ABSTRACT

A relay station that includes a receiver that receives, from a transmitter station, a signal in which known data used for propagation path estimation is assigned to a first region determined by a combination of a frequency domain and a time domain and predetermined data is assigned to a second region that is different from the first region. The relay station also includes a processor that performs processing for generating a signal in which the known data is assigned to the second region in the signal received by the receiver, and a transmitter that transmits the signal generated by the processor.

### CROSS-REFERENCE TO RELATED APPLICATIONS

This application is based upon and claims the benefit of priority from the prior Japanese Patent Application No. 2010-184391 filed on Aug. 19, 2010, the entire contents of which are incorporated herein by reference.

### FIELD

The present invention relates to a wireless communication system, a relay station, a receiver station, and a wireless communication method.

### BACKGROUND

A wireless communication system includes, for example, a transmitter station, such as a base station, and a receiver station, such as a mobile terminal device. When in a communication area covered by the transmitter station, the receiver station performs wireless communication with the transmitter station.

In recent years, in the wireless communication system, a relay station for relaying signals transmitted/received between the transmitter station and the receiver station may be installed in order to expand the communication area. An amplify-and-forward (AF) scheme is available as a relay scheme for the relay station. The relay station that performs relay processing based on the AF scheme amplifies a signal received from the transmitter station and transmits the amplified signal having the same frequency as the signal received from the transmitter station. In a wireless communication system employing such an AF scheme, the same signals transmitted from both of the transmitter station and the relay station may arrive at the receiver station in a spatially multiplexed manner. As a result, in the wireless communication system employing the AF scheme, the quality of the signals received by the receiver station may be improved. Technologies related to the wireless communication system that performs wireless communication using a relay station are disclosed in, for example, Japanese Laid-open Patent Publication No. 2007-295569, Japanese Laid-open Patent Publication No. 2007-500482, Japanese Laid-open Patent Publication No. 2003-198442, and Japanese Laid-open Patent Publication No. 2008-17487.

### SUMMARY

According to an aspect of the invention, a wireless communication system in which a transmitter station and a receiver station are capable of performing wireless communication via a relay station is disclosed. The transmitter station includes a first processor that generates a first signal in which known data is assigned to a first region determined by a combination of a frequency domain and a time domain, and a first transmitter that transmits the first signal generated by the first processor. The relay station includes a second processor that generates a second signal in which the known data is assigned to a second region that is different from the first region in the first signal transmitted by the first transmitter, and a second transmitter that transmits the second signal generated by the second processor. The receiver station includes a receiver that receives the first and second signals, and a third processor that separates the first and second signals received by the receiver, based on the known data assigned to the first region and the known data assigned to the second region.

The object and advantages of the invention will be realized and attained by means of the elements and combinations particularly pointed out in the claims.

It is to be understood that both the foregoing general description and the following detailed description are example of and explanatory and are not restrictive of the invention, as claimed.

### BRIEF DESCRIPTION OF DRAWINGS

FIG. 1 is a diagram illustrating an example of configuration of a wireless communication system according to a first embodiment;

FIG. 2 illustrates examples of signals transmitted/received by a relay station in the first embodiment;

FIG. 3 illustrates examples of signals received by a receiver station in the first embodiment;

FIG. 4 is a block diagram illustrating an example of configuration of the transmitter station in the first embodiment;

FIG. 5 is a block diagram illustrating an example of configuration of the relay station in the first embodiment;

FIG. 6 is a block diagram illustrating an example of configuration of the receiver station in the first embodiment;

FIG. 7 is a sequence diagram illustrating a procedure of processing performed by the wireless communication system according to the first embodiment;

FIG. 8 illustrates examples of signals transmitted/received by the relay station in the first embodiment;

FIG. 9 illustrates examples of signals received by the receiver station in the first embodiment; and

FIG. 10 illustrates examples of signals that a receiver station of related art receives from a transmitter station and a relay station.

### DESCRIPTION OF EMBODIMENTS

In the related art described above, there are cases in which the quality of the signals received by the receiver station deteriorates. More specifically, in the wireless communication system including the relay station, the receiver station may receive a signal resulting from interference between a signal transmitted from the transmitter station and a signal transmitted from the relay station.

A reason why the receiver station receives an interfered signal will now be described. The relay station performs predetermined signal processing on the signal received from the transmitter station. For example, the relay station performs signal processing, such as processing for amplifying the received signal, demodulation processing, and modulation processing. There are also cases in which the relay station receives the signal, transmitted to the receiver station, via a transmitter-station-oriented antenna for transmitting/receiving a signal to/from the transmitter station. Such a signal is called “diffraction waves,” which may cause the internal circuitry of the relay station to oscillate. Thus, in order to prevent the oscillation, the relay station performs digital signal processing to eliminate the diffraction waves.

Since the relay station performs various types of signal processing as described above, the relay station transmits a signal to the receiver station when a period of time taken for the signal processing passes after the reception of the signal transmitted by the transmitter station. When the delay time caused by the signal processing performed by the relay station is larger than a predetermined value, there are cases in which different signals transmitted by the transmitter and the relay station arrive at the receiver station at the same time. That is, there are cases in which the receiver station receives a signal in which the different signals transmitted by the transmitter station and the relay station are spatially multiplexed. Such a signal may cause interference, which results in a problem in that the quality of the signal received by the receiver station deteriorates.

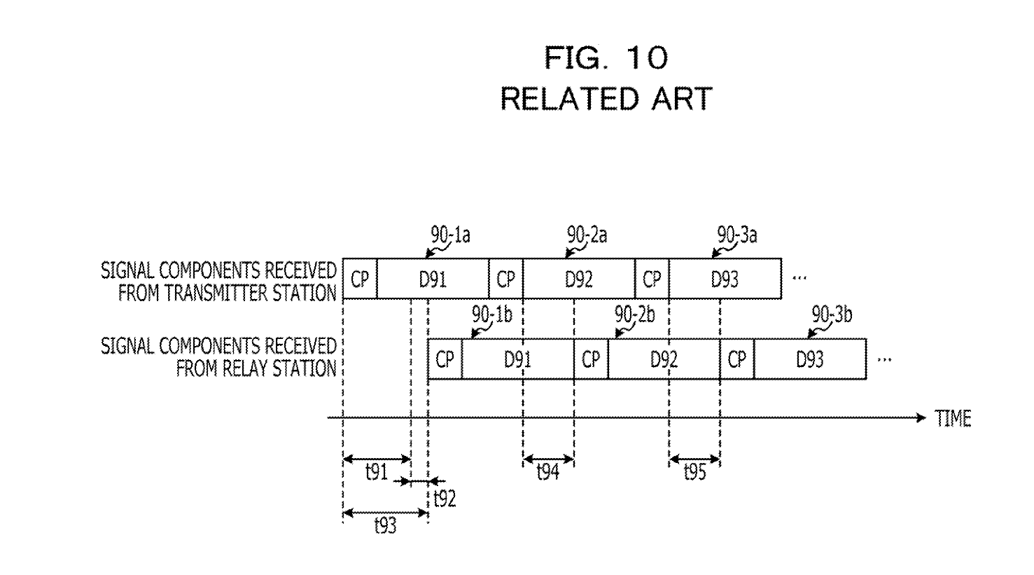

The problem will now be described with reference to FIG. 10. FIG. 10 illustrates examples of signals that a receiver station of the related art receives from a transmitter station and a relay station. In the examples illustrated in FIG. 10, it is assumed that orthogonal frequency division multiplexing (OFDM) is used as a transmission scheme. The upper stage in FIG. 10 illustrates signal components that the receiver station receives from the transmitter station and the lower stage in FIG. 10 illustrates signal components that the receiver station receives from the relay station. Although FIG. 10 illustrates an example in which the signal received by the receiver station is divided into signal components, signal components that are simultaneously received by the receiver station are spatially multiplexed in practice.

In the example illustrated in FIG. 10, the transmitter station transmits an OFDM symbol 90-1a containing a cyclic prefix (CP) and a data signal D91, an OFDM symbol 90-2a containing a CP and a data signal D92, and an OFDM symbol 90-3a containing a CP and a data signal D93. The relay station of the related art performs signal processing on the OFDM symbols 90-1a to 90-3a received from the transmitter station and then transmits signal-processed OFDM symbols 90-1b to 90-3b. The OFDM symbol 90-1b is an OFDM symbol obtained by performing the signal processing on the OFDM symbol 90-1a, the OFDM symbol 90-2b is an OFDM symbol obtained by performing the signal processing on the OFDM symbol 90-2a, and the OFDM symbol 90-3b is an OFDM symbol obtained by performing the signal processing on the OFDM symbol 90-3a.

Time “t91” illustrated in FIG. 10 indicates the amount of time taken for the signal processing performed by the relay station. Time “t92” illustrated in FIG. 10 indicates a propagation delay difference that occurs since the path from the transmitter station to the receiver station and the path from the relay station to the receiver station are different from each other. That is, the signal transmitted from the transmitter station arrives at the relay station with a delay corresponding to a time “t93=t91+t92” relative to the signal transmitted from the transmitter station.

As illustrated in FIG. 10, when the amount of delay time “t93” is larger than the duration of the CP, different OFDM symbols in the signals transmitted from the transmitter station and the relay station are spatially multiplexed to thereby cause inter-OFDM-symbol interference. More specifically, the OFDM symbol 90-1b transmitted from the relay station is spatially multiplexed with both the OFDM symbols 90-1a and 90-2a transmitted from the transmitter station and the OFDM symbol 90-2b transmitted from the relay station is spatially multiplexed with both the OFDM symbols 90-2a and 90-3a transmitted from the transmitter station. Thus, in the period of time “t94”, the receiver station receives a signal resulting from interference between the different OFDM symbols 90-2a and 90-1b, and in the period of time “t95”, the receiver station receives a signal resulting from interference between the OFDM symbols 90-3a and 90-2b. For such a reason, in the wireless communication system including the relay station, when the amount of delay caused by the signal processing performed by the transmitter station is larger than the duration of the CP, the quality of the signals received by the receiver station may deteriorate.

Embodiments of a wireless communication system, a relay station, a receiver station, and a wireless communication method disclosed herein will be described below in detail with reference to the accompanying drawings. The embodiments, however, are not intended to limit the wireless communication system, the relay station, the receiver station, and the wireless communication method disclosed herein. A wireless communication system that uses Orthogonal Frequency Division Multiplexing (OFDM) as one example of a transmission scheme will be described in the following embodiments by way of example. The wireless communication system disclosed herein, however, is also applicable to a wireless communication system that uses another transmission scheme, such as Orthogonal Frequency Division Multiple Access (OFDMA).

### First Embodiment

### Configuration of Wireless Communication System of First Embodiment

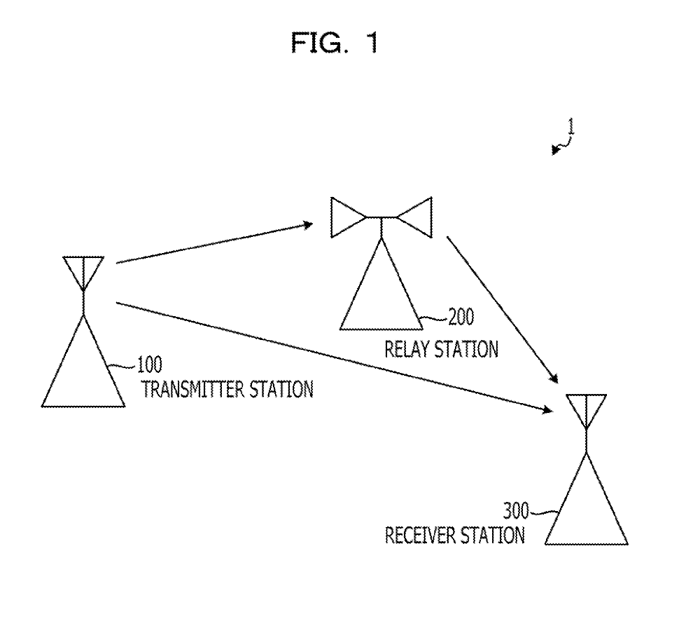

First, a wireless communication system according to a first embodiment will be described with reference to FIG. 1. FIG. 1 is a diagram illustrating an example of configuration of a wireless communication system according to a first embodiment. As illustrated in FIG. 1, a wireless communication system 1 according to a first embodiment includes a transmitter station 100, a relay station 200, and a receiver station 300.

The transmitter station 100 is, for example, a base station and transmits a signal to the receiver station 300. Since the wireless communication system 1 according to the first embodiment employs OFDM as a transmission scheme, the signal transmitted by the transmitter station 100 is frequency-multiplexed and is represented by frequency domain and time domain. That is, the transmitter station 100 assigns control data and user data to each resource region determined by a combination of a predetermined frequency domain and a predetermined time domain, to thereby generate a transmission signal.

The transmitter station 100 in the first embodiment assigns a known signal to a first resource region determined by a combination of a predetermined frequency domain and a predetermined time domain and also assigns predetermined data to a second resource region that is different from the first resource region. The expression “predetermined data” includes, for example, null data and data containing a null symbol with a transmission power of zero. That is, the transmitter station 100 does not use the second resource region to transmit control data and user data. The known signal is also referred to as a “pilot signal”, a “reference signal”, or the like, and is used when the receiver station 300 or the like performs channel estimation (also called “propagation-path estimation”) and so on. A signal generated by the transmitter station 100 in the first embodiment may be referred to as a “transmitter-station signal”. Hereinafter, the predetermined data, such as a null symbol, may be referred to as “null data”.

Upon receiving a transmitter-station signal from the transmitter station 100, the relay station 200 in the first embodiment relays the transmitter-station signal to the receiver station 300. The relay station 200 performs, for example, signal processing for eliminating diffraction waves from the transmitter-station signal. The relay station 200 in the first embodiment interchanges the mapping positions of the known signal and the null data assigned in the transmitter-station signal. More specifically, the relay station 200 assigns the known signal, assigned to the first resource region in the transmitter-station signal, to the second resource region and sets the first resource region as a reserved region. For example, the relay station 200 assigns null data to the first resource region. A signal generated by the relay station 200 in the first embodiment may be referred to as a “relay signal” hereinafter.

The relay station 200 transmits the thus-generated relay signal with a delay corresponding to a predetermined amount of time. More specifically, the relay station 200 transmits the generated relay signal with a delay corresponding to the amount of time obtained by subtracting the time taken for the signal processing from the duration of the relay signal.

The receiver station 300 may be a mobile terminal device, such as a mobile phone, a personal handy-phone system (PHS), or a personal digital assistant (PDA). The receiver station 300 in the first embodiment receives a signal in which the transmitter-station signal transmitted by the transmitter station 100 and the relay signal transmitted by the relay station 200 are spatially multiplexed.

The first resource regions in the signal received by the receiver station 300 are assigned known signals transmitted by the transmitter station 100. The first resource regions are assigned null data by the relay station 200. The second resource regions in the signal received by the receiver station 300 are assigned known signals transmitted by the relay station 200. The second resource regions are assigned null data by the transmitter station 100. That is, the first resource regions in the signal received by the receiver station 300 are assigned only the known signals transmitted by the transmitter station 100 and the second resource regions are assigned only the known signals transmitted by the relay station 200.

Thus, upon receiving the spatially multiplexed signal from the transmitter station 100 and the relay station 200, the receiver station 300 may extract the known signals assigned by the transmitter station 100 from the first resource regions in the received signal. In addition, the receiver station 300 may extract the known signals, assigned by the relay station 200, from the second resource regions in the received signal.

Assigning the known signals of the signals transmitted by the transmitter station 100 to the first resource regions and assigning the null data to the second resource regions may be predetermined for the system. For example, based on the number of known-signal resource blocks (RBs) contained in the resource-assignment information, the receiver station 300 may determine the frequency band of the known signals of the signals transmitted by the transmitter station 100. When no signals are assigned to the frequency band of the known signals transmitted by the transmitter station 100, the receiver station 300 may determine that known signals transmitted by the relay station 200 are contained in the frequency band to which null data, such as null symbols, are assigned.

With this arrangement, the receiver station 300 may independently perform channel estimation processing on the transmitter-station signal directly received from the transmitter station 100 and the relay signal received from the relay station 200. By performing such independent channel estimation processing, the receiver station 300 separates the spatially multiplexed signal by using a channel separation algorithm for Multiple-Input Multiple-Output (MIMO). More specifically, upon receiving a spatially multiplexed signal from the transmitter station 100 and the relay station 200, the receiver station 300 separates the signal into a transmitter-station signal and a relay signal.

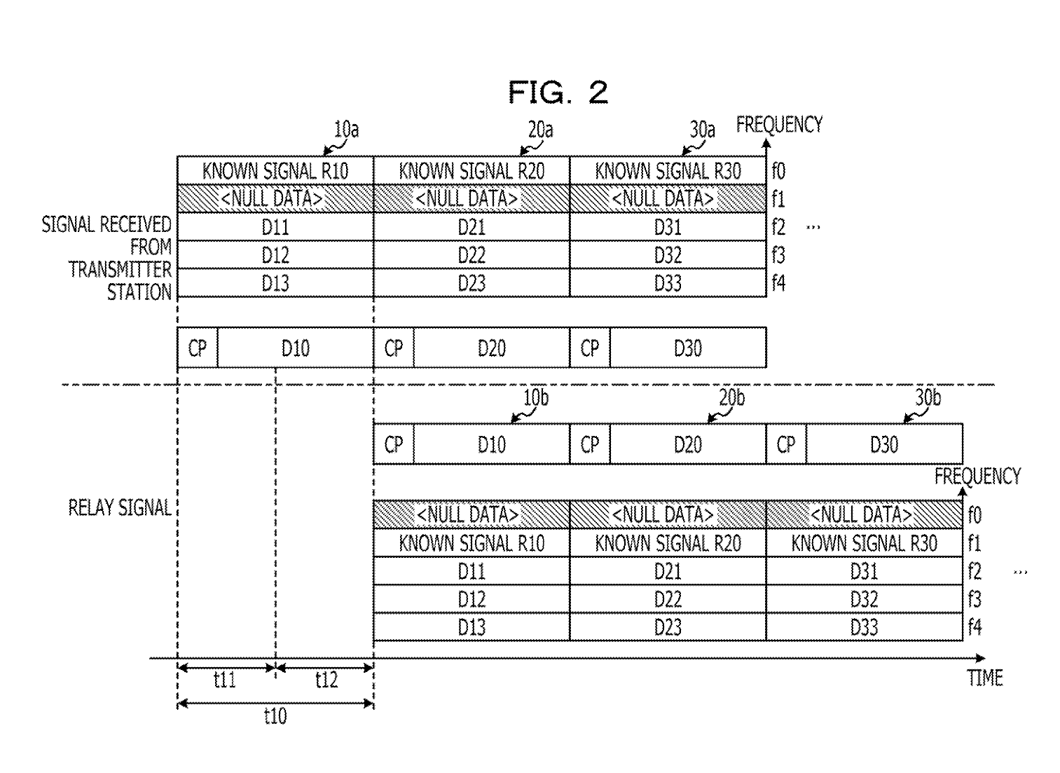

Signals transmitted/received by the relay station 200 will now be described with reference to FIG. 2. FIG. 2 illustrates examples of signals transmitted/received by the relay station 200 in the first embodiment. The upper stage in FIG. 2 illustrates one example of a transmitter-station signal that the relay station 200 receives from the transmitter station 100. The lower stage in FIG. 2 illustrates one example of a relay signal transmitted by the relay station 200.

In the example illustrated in FIG. 2, the transmitter station 100 transmits OFDM symbols 10a, 20a, and 30a. More specifically, as illustrated in the upper stage in FIG. 2, the transmitter station 100 transmits an OFDM symbol 10a in which a frequency domain “f0” is assigned a known signal R10 and a frequency domain “f1” is assigned null data, an OFDM symbol 20a in which a frequency domain “f0” is assigned a known signal R20 and a frequency domain “f1” is assigned null data, and an OFDM symbol 30a in which a frequency domain “f0” is assigned a known signal R30 and a frequency domain “f1” is assigned null data.

When the relay station 200 receives the transmitter-station signal illustrated in the upper stage in FIG. 2, it interchanges the mapping positions of the known signals and the null data contained in the transmitter-station signal, to thereby generate a relay signal, as illustrated in the lower stage in FIG. 2.

More specifically, the relay station 200 assigns the known signal R10, assigned to the frequency domain “f0” in the OFDM symbol 10a, to the frequency domain “f1” and assigns the null data to the frequency domain “f0”, to thereby generate an OFDM symbol 10b. In this case, the relay station 200 does not change the mapping positions of data signals D11 to D13 assigned to frequency domains other than the frequency domains “f0” and “f1” in the OFDM symbol 10a. The term “data signals” as used herein refer to, for example, control signals containing control data and user-data signals containing user data.

Similarly, the relay station 200 assigns the known signal R20, assigned to the frequency domain “f0” in the OFDM symbol 20a, to the frequency domain “f1” and assigns the null data to the frequency domain “f0”, to thereby generate an OFDM symbol 20b. The relay station 200 also assigns the known signal R30, assigned to the frequency domain “f0” in the OFDM symbol 30a, to the frequency domain “f1” and assigns the null data to the frequency domain “f0”, to thereby generate an OFDM symbol 30b.

In the manner described above, the relay station 200 generates a relay signal from a transmitter-station signal received from the transmitter station 100. The relay station 200 then transmits the relay signal with a delay corresponding to the amount of time obtained by subtracting the time taken for the signal processing from the OFDM symbol duration. For example, time “t11” illustrated in FIG. 2 is assumed to indicate the amount of time taken for the signal processing performed by the relay station 200. In this case, the relay station 200 transmits the relay signal, such as the OFDM symbols 10b, 20b, and 30b, with a delay corresponding to a time “t12” obtained by subtracting the signal processing time “t11” from the OFDM symbol duration “t10”.

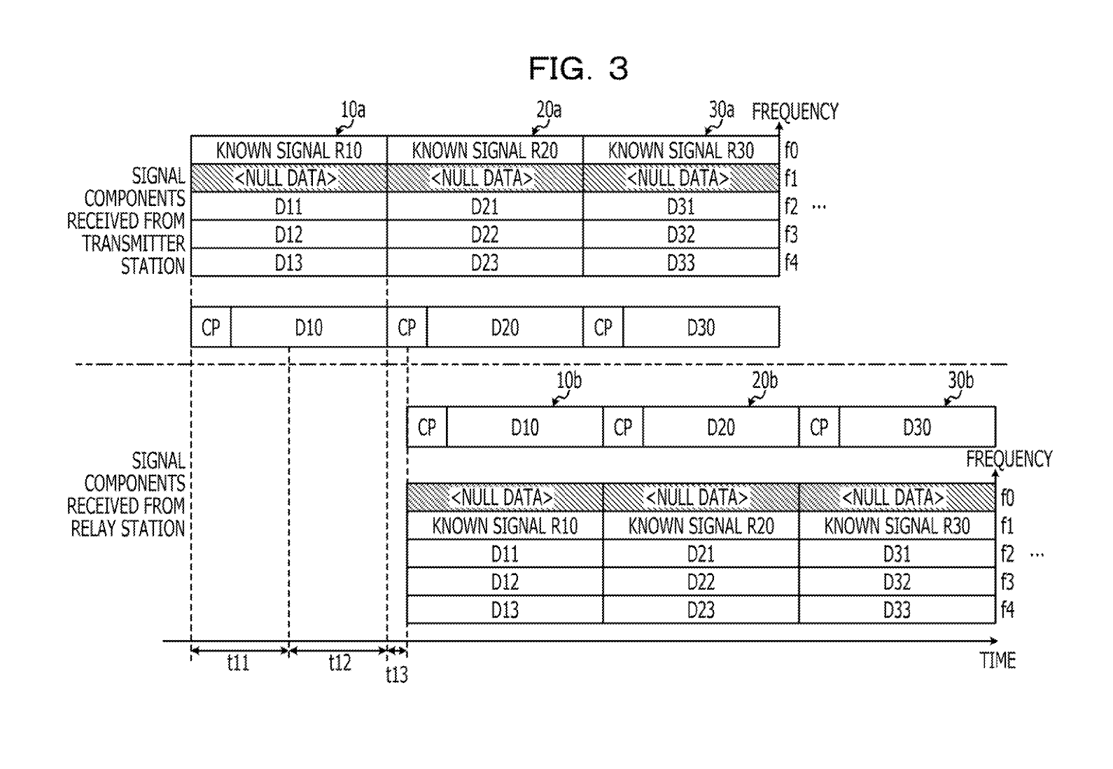

Next, signals received by the receiver station 300 when the relay signal illustrated in the lower stage in FIG. 2 is transmitted by the relay station 200 will be described with reference to FIG. 3. FIG. 3 illustrates examples of signals received by the receiver station 300 in the first embodiment. The upper stage in FIG. 3 illustrates signal components that the receiver station 300 receives from the transmitter station 100 and the lower stage in FIG. 3 illustrates signal components that the receiver station 300 receives from the relay station 200. Although the signal components transmitted from the transmitter station 100 and the signal components transmitted from the relay station 200 are separately illustrated in FIG. 3, signal components that are simultaneously received by the receiver station 300 are spatially multiplexed in practice. Time “t13” illustrated in FIG. 3 indicates a propagation delay difference that occurs since a path of a transmitter-station signal and a path of a relay signal are different from each other.

As illustrated in FIG. 3, the receiver station 300 receives a signal in which the OFDM symbols 10a, 20a, and 30a transmitted by the transmitter station 100 and the OFDM symbols 10b, 20b, and 30b transmitted by the relay station 200 are spatially multiplexed. More specifically, the OFDM symbols 20a and 30a transmitted by the transmitter station 100 and the OFDM symbols 10b and 20b transmitted by the relay station 200 are spatially multiplexed.

In the example illustrated in FIG. 3, since the OFDM symbol 10a is not spatially multiplexed with another OFDM symbol, the receiver station 300 may extract the known signal R10 from the OFDM symbol 10a. Based on the known signal R10, the receiver station 300 extracts the data signals D11 to D13 from the OFDM symbol 10a.

In the OFDM symbol in which the OFDM symbols 20a and 10b are spatially multiplexed, the frequency domain “f0” is assigned only the known signal R20 and the frequency domain “f1” is assigned only the known signal R10. Thus, the receiver station 300 may extract, from the OFDM symbol in which the OFDM symbols 20a and 10b are spatially multiplexed, the known signal R20 transmitted by the transmitter station 100 and the known signal R10 transmitted by the relay station 200.

The receiver station 300 uses the extracted known signals R20 and R10 to perform independent channel estimation processing on the path of the transmitter-station signal and the path of the relay signal. As a result, the receiver station 300 separates the OFDM symbol in which the OFDM symbols 20a and 10b are spatially multiplexed into the OFDM symbol 20a and the OFDM symbol 10b. The receiver station 300 then extracts the data signals D21 to D23 from the separated OFDM symbol 20a and also extracts the data signals D11 to D13 from the separated OFDM symbol 10b.

Similarly, the receiver station 300 separates the OFDM symbol in which the OFDM symbols 30a and 20b are spatially multiplexed into the OFDM symbol 30a and the OFDM symbol 20b. The receiver station 300 then extracts data signals D31 to D33 from the separated OFDM symbol 30a and also extracts data signals D21 to D23 from the separated OFDM symbol 20b. The receiver station 300 also extracts data signals D31 to D33 from the OFDM symbol 30b.

The receiver station 300 then combines the same data signals of the data signals extracted from the OFDM symbols 10a, 20a, 30a, 10b, 20b, and 30b. More specifically, the receiver station 300 stores, in a predetermined buffer, the data D11 to D13 extracted from the OFDM symbol 10a. The receiver station 300 then combines the data signal D11 extracted from the OFDM symbol 10b and the data D11 stored in the buffer. In the same manner, the receiver station 300 performs combination with respect to the data D12 and D13. The receiver station 300 performs log-likelihood ratio (LLR) combining processing for combining likelihood information of the same data contained in the OFDM symbols.

As described above, the transmitter station 100 in the first embodiment transmits a transmitter-station signal in which known signals and null data are assigned. Upon receiving the transmitter-station signal, the relay station 200 in the first embodiment transmits a relay signal in which the mapping positions of the known signals and the null data are interchanged. Even when receiving the spatially multiplexed signal from the transmitter station 100 and the relay station 200, the receiver station 300 may perform independent channel estimation processing on the path of the transmitter-station signal and the path of the relay signal. Thus, upon receiving the spatially multiplexed signal from the transmitter station 100 and the relay station 200, the receiver station 300 in the first embodiment may perform reception processing that is similar to reception processing for a MIMO-compliant transmitter station. Hence, the wireless communication system 1 according to the first embodiment may improve the quality of the signals received by the receiver station 300.

Although FIG. 2 illustrates an example in which the transmitter station 100 assigns known signals to the frequency domains “f0” and assigns null data to the frequency domains “f1”, the resource regions to which the transmitter station 100 assigns the known signals and null data are not limited to the example illustrated in FIG. 2. Specifically, the transmitter station 100 may assign the known signals and null data to different resource regions. For example, in the example illustrated in FIG. 2, the transmitter station 100 may assign the known signals to the frequency domains “f1” and assign the null data to the frequency domains “f2”.

Although no description has been given above, the relay station 200 in the wireless communication system 1 in the first embodiment may relay the signal to a specific receiver station and does not need to relay the signal to a receiver station other than the specific receiver station. The transmitter station 100 may transmit the transmitter-station signal (illustrated in the upper stage in FIG. 2) to the specific receiver station and does not need to transmit, to a receiver station other than the specific receiver station.

### Configuration of Transmitter Station in First Embodiment

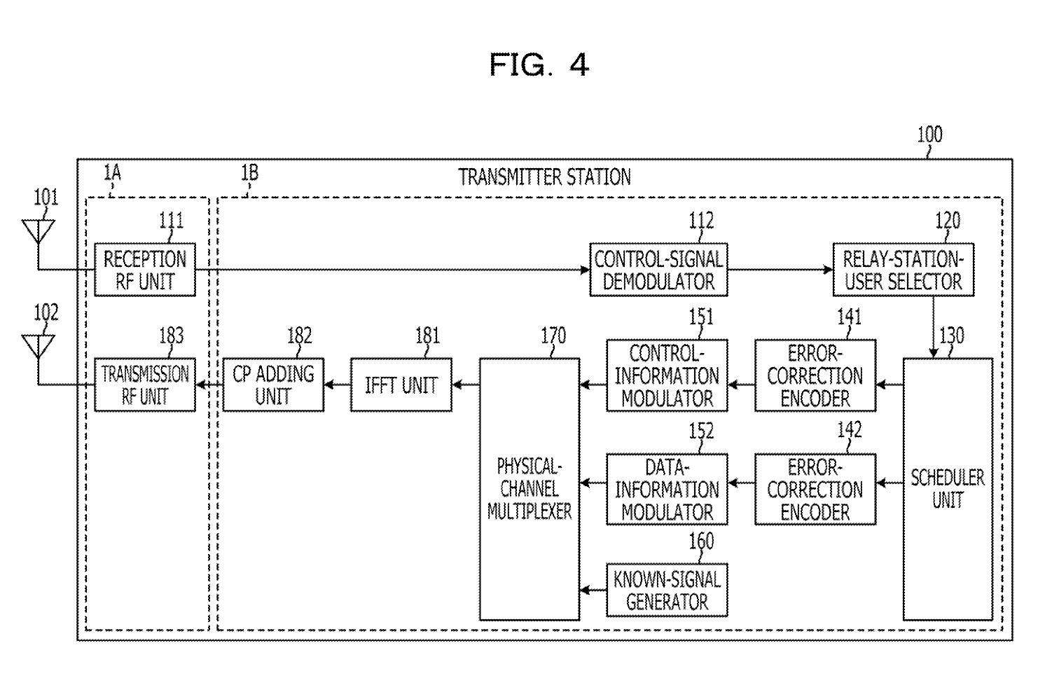

The transmitter station 100 in the first embodiment will be described next with reference to FIG. 4. FIG. 4 is a block diagram of an example of configuration of the transmitter station 100 in the first embodiment. As illustrated in FIG. 4, the transmitter station 100 includes antennas 101 and 102, a reception radio-frequency (RF) unit 111, a control-signal demodulator 112, and a relay-station-user selector 120.

The antenna 101 receives a signal transmitted from an external apparatus (not illustrated). The antenna 101 receives, for example, an uplink signal transmitted from the receiver station 300. The antenna 102 transmits a signal to an external apparatus (not illustrated). For example, the antenna 102 transmits a downlink signal to the relay station 200 and the receiver station 300. Although FIG. 4 illustrates an example in which the transmitter station 100 has both the receive antenna 101 and the transmit antenna 102, the transmitter station 100 may have a shared antenna via which transmission and reception are possible, instead of the receive antenna 101 and the transmit antenna 102.

The reception RF unit 111 performs various types of processing on the signal received by the antenna 101. Examples of the processing that the reception RF unit 111 performs include frequency conversion processing for converting a radio frequency band into a baseband, orthogonal demodulation processing, and analog-to-digital (A/D) conversion processing.

The control-signal demodulator 112 performs demodulation processing and the like on, of the signals output from the reception RF unit 111, the control signal transmitted by the receiver station 300. The control signal transmitted by the receiver station 300 contains position information indicating the location of the receiver station 300. Upon receiving the control signal containing the position information from the receiver station 300, the control-signal demodulator 112 extracts the receiver station 300 position information from the control signal.

Based on the receiver station 300 position information output from the control-signal demodulator 112, the relay-station-user selector 120 determines whether or not the receiver station 300 is to be set as a receiver station for receiving a signal relayed by the relay station 200. The receiver station for receiving the signal relayed by the relay station 200 may be referred to as a “relay-station user” hereinafter.

More specifically, when the distance between the receiver station 300 and the relay station 200 is smaller than a predetermined threshold, the relay-station-user selector 120 determines that the receiver station 300 is to be set as the relay-station user. On the other hand, when the distance between the receiver station 300 and the relay station 200 is larger than or equal to the predetermined threshold, the relay-station-user selector 120 determines that the receiver station 300 is not to be set as the relay-station user. This is because, when the receiver station 300 and the relay station 200 are not located a short distance from each other, there are, for example, a case in which the receiver station 300 is not located within the communication area of the relay station 200 and a case in which the receiver station 300 may not receive the signal, relayed by the relay station 200, with a high quality.

The transmitter station 100 also receives a data signal containing user data and so on and performs reception processing on the data signal. A description of the reception processing performed on the data signal including user data and so on is omitted in FIG. 4.

As illustrated in FIG. 4, the transmitter station 100 further includes a scheduler unit 130, error-correction encoders 141 and 142, a control-information modulator 151, a data-information modulator 152, a known-signal generator 160, and a physical-channel multiplexer 170. The transmitter station 100 further includes an inverse fast Fourier transform (IFFT) unit 181, a cyclic prefix (CP) adding unit 182, and a transmission RF unit 183.

The scheduler unit 130 assigns control data, user data, and so on to be transmitted to the receiver station 300 to resources. More specifically, the scheduler unit 130 outputs, to the error-correction encoder 141, resource-assignment information regarding the resources assigned the user data and so on and control data containing, for example, information indicating that the receiver station 300 is the relay-station user. The scheduler unit 130 outputs, to the error-correction encoder 142, the user data assigned to the resources.

When the relay-station-user selector 120 determines that the receiver station 300 is to be set as the relay-station user, the scheduler unit 130 outputs, to the error-correction encoder 141, information indicating that the receiver station 300 is the relay-station user. On the other hand, when the relay-station-user selector 120 determines that the receiver station 300 is not to be set as the relay-station user, the scheduler unit 130 outputs, to the error-correction encoder 141, information indicating that the receiver station 300 is not the relay-station user. The information indicating whether or not the receiver station 300 is the relay-station user may hereinafter be referred to as “relay-station-user information”.

The error-correction encoder 141 performs error-correction encoding processing on the control data assigned to the resources by the scheduler unit 130. The error-correction encoder 142 performs error-correction encoding processing on the user data assigned to the resources by the scheduler unit 130.

The control-information modulator 151 generates a control signal by performing modulation processing on the control data on which the error-correction encoding processing was performed by the error-correction encoder 141. The data-information modulator 152 generates a user-data signal by performing modulation processing on the user data on which the error-correction encoding processing was performed by the error-correction encoder 142.

The known-signal generator 160 generates a known signal that is known to the receiver station 300. The known signal generated by the known-signal generator 160 is also called a “pilot signal” or “reference signal” and is used when the receiver station 300 performs channel estimation processing and so on.

The physical-channel multiplexer 170 frequency-multiplexes the control signal output from the control-information modulator 151, the user data output from the data-information modulator 152, and the known signal output from the known-signal generator 160.

For frequency-multiplexing the known signal, the physical-channel multiplexer 170 in the first embodiment assigns null data to a predetermined frequency domain. For example, as in the example illustrated in the upper stage in FIG. 2, for each OFDM symbol, the physical-channel multiplexer 170 assigns a known signal to a predetermined frequency domain “f0” and assigns null data to a frequency domain “f1” that is different from the frequency domain “f0”.

The IFFT unit 181 generates a time-domain signal by performing IFFT processing on the frequency-domain signal frequency-multiplexed by the physical-channel multiplexer 170. The CP adding unit 182 divides the signal, generated by the IFFT unit 181, into signals according to an OFDM symbol duration, and adds a CP to each of the signals having the OFDM symbol duration.

The transmission RF unit 183 performs various types of processing on the signal output from the CP adding unit 182. Examples of the processing that the transmission RF unit 183 performs on the signal output from the CP adding unit 182 include digital-to-analog (D/A) conversion processing, orthogonal modulation processing, and frequency conversion processing for converting a baseband into a radio frequency band. The transmission RF unit 183 outputs a signal, obtained by the various types of processing, via the antenna 102.

The reception RF unit 111 and the transmission RF unit 183 are included in an RF processor 1A, which may be realized by hardware, for example, an integrated circuit, such as an application specific integrated circuit (ASIC) or a field programmable gate array (FPGA). The control-signal demodulator 112, the relay-station-user selector 120, the scheduler unit 130, the error-correction encoders 141 and 142, the control-information modulator 151, the data-information modulator 152, the known-signal generator 160, the physical-channel multiplexer 170, the IFFT unit 181, and the CP adding unit 182 are included in a baseband processor 1B, which may be realized by, for example, hardware, such as a central processing unit (CPU) or a micro processing unit (MPU). That is, the RF processor 1A and the baseband processor 1B may be realized by pieces of hardware that are different from each other. The baseband processor 1B is one example of a first processor.

### Configuration of Relay Station in First Embodiment

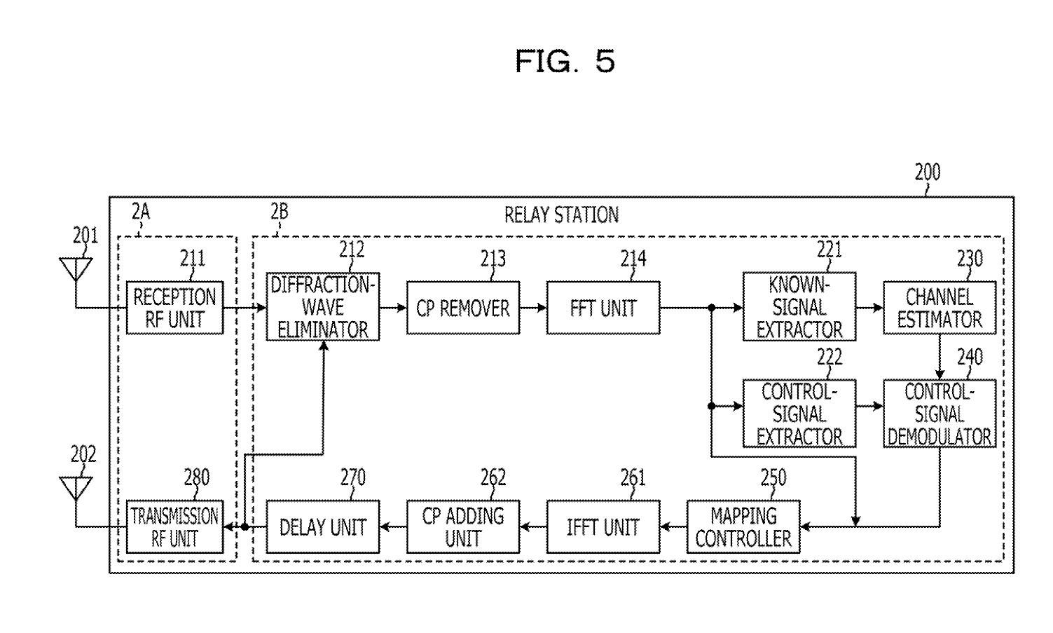

The relay station 200 in the first embodiment will be described next with reference to FIG. 5. FIG. 5 is a block diagram illustrating an example of configuration of the relay station 200 in the first embodiment. As illustrated in FIG. 5, the relay station 200 includes antennas 201 and 202, a reception RF unit 211, a diffraction-wave eliminator 212, a CP remover 213, and a fast Fourier transform (FFT) unit 214.

The antenna 201 receives a signal transmitted from an external apparatus (not illustrated). The antenna 201 receives, for example, a signal transmitted from the transmitter station 100. The antenna 202 transmits a signal to an external apparatus (not illustrated). The antenna 202 transmits a signal to, for example, the receiver station 300. The relay station 200 may have a shared antenna via which transmission and reception are possible, instead of the antennas 201 and 202.

In the example illustrated in FIG. 5, the signal transmitted from the transmit antenna 202 may be received, as diffraction waves, by the receive antenna 201. When received by the receive antenna 201, such diffraction waves may cause internal circuitry of the relay station 200 to oscillate.

The reception RF unit 211 performs various types of processing on the signal received by the antenna 201. For example, similarly to the reception RF unit 111 illustrated in FIG. 4, the reception RF unit 211 performs frequency conversion processing, orthogonal demodulation processing, A/D conversion processing, and so on.

By using the signal output from a delay unit 270 (described below), the diffraction-wave eliminator 212 eliminates diffraction waves from the signal input from the reception RF unit 211. With this arrangement, even when the antenna 201 receives diffraction waves, the diffraction-wave eliminator 212 may prevent the internal circuitry of the relay station 200 from oscillating.

The CP remover 213 removes the CP from the signal output from the diffraction-wave eliminator 212. The FFT unit 214 performs FFT processing on a signal, output from the CP remover 213, to generate a frequency-domain signal.

As illustrated in FIG. 5, the relay station 200 includes a known-signal extractor 221, a control-signal extractor 222, a channel estimator 230, a control-signal demodulator 240, and a mapping controller 250.

The known-signal extractor 221 extracts the known signal from the frequency-domain signal generated by the FFT unit 214. The control-signal extractor 222 extracts the control signal from the frequency-domain signal generated by the FFT unit 214.

The channel estimator 230 performs channel estimation processing based on the known signal extracted by the known-signal extractor 221. The control-signal demodulator 240 performs, for example, channel-compensation processing, demodulation processing, and error-correction decoding processing on the control signal extracted by the control-signal extractor 222. As a result, the control-signal demodulator 240 extracts the resource-assignment information, the relay-station-user information, and so on from the control signal transmitted by the transmitter station 100. The control-signal demodulator 240 then outputs the resource-assignment information, the relay-station-user information, and so on to the mapping controller 250.

Based on the multiple types of information output from the control-signal demodulator 240, the mapping controller 250 performs processing for adjusting the mapping positions of subcarriers with respect to the frequency-domain signal output from the FFT unit 214.

More specifically, the mapping controller 250 determines whether or not the receiver station 300 is the relay-station user, based on the relay-station-user information output from the control-signal demodulator 240. When the receiver station 300 is not the relay-station user, the mapping controller 250 substitutes “0” for the signal included in the signals output from the FFT unit 214 and destined for the receiver station 300. This is because, when the receiver station 300 is not the relay-station user, the relay station 200 does not relay the signal, received from the transmitter station 100 and destined for the receiver station 300, to the receiver station 300.

On the other hand, when the receiver station 300 is the relay-station user, the mapping controller 250 interchanges the mapping positions of the known signals and the null data assigned to the signals destined for the receiver station 300. That is, the mapping controller 250 assigns, of the signals destined for the receiver station 300, the known signals to the resource regions to which the null data has been assigned and also assigns the null data to the resource regions to which the known signal has been assigned.

As illustrated in FIG. 5, the relay station 200 further includes an IFFT unit 261, a CP adding unit 262, a delay unit 270, and a transmission RF unit 280. The IFFT unit 261 performs IFFT processing on a signal, output from the mapping controller 250, to generate a time-domain signal. The CP adding unit 262 divides the signal, generated by the IFFT unit 261, into signals according to an OFDM symbol duration, and adds a CP to each of the signals having the OFDM symbol duration.

After waiting for a period of time obtained by subtracting the time taken for the signal processing from the duration of the relay signal transmitted by the relay station 200, the delay unit 270 outputs the signal, input from the CP adding unit 262, to the transmission RF unit 280. The time taken for the signal processing corresponds to, for example, the time from when the antenna 201 receives the signal until the CP adding unit 262 completes the CP addition processing.

For example, when the transmitter station 100 assigns a known signal to each of N OFDM symbols, the delay unit 270 waits for a period of time obtained by subtracting the time taken for the signal processing from N-times the OFDM symbol duration. In the example illustrated in FIG. 3, the transmitter station 100 assigns a known signal to each OFDM symbol. In such a case, the delay unit 270 waits for a period of time obtained by subtracting the time taken for the signal processing from the duration of one OFDM symbol.

The transmission RF unit 280 performs various types of processing on the signal output from the delay unit 270. For example, similarly to the transmission RF unit 183 illustrated in FIG. 4, the transmission RF unit 280 performs D/A conversion processing, orthogonal modulation processing, frequency conversion processing, and so on.

The reception RF unit 211 and the transmission RF unit 280 are included in an RF processor 2A, which may be realized by hardware, for example, an integrated circuit, such as an ASIC or FPGA. The diffraction-wave eliminator 212, the CP remover 213, the FFT unit 214, the known-signal extractor 221, the control-signal extractor 222, the channel estimator 230, the control-signal demodulator 240, the mapping controller 250, the IFFT unit 261, the CP adding unit 262, and the delay unit 270 are included in a baseband processor 2B, which may be realized by hardware, such as a CPU or MPU. That is, the RF processor 2A and the baseband processor 2B may be realized by pieces of hardware that are different from each other. The baseband processor 2B is one example of a second processor.

### Configuration of Receiver Station in First Embodiment

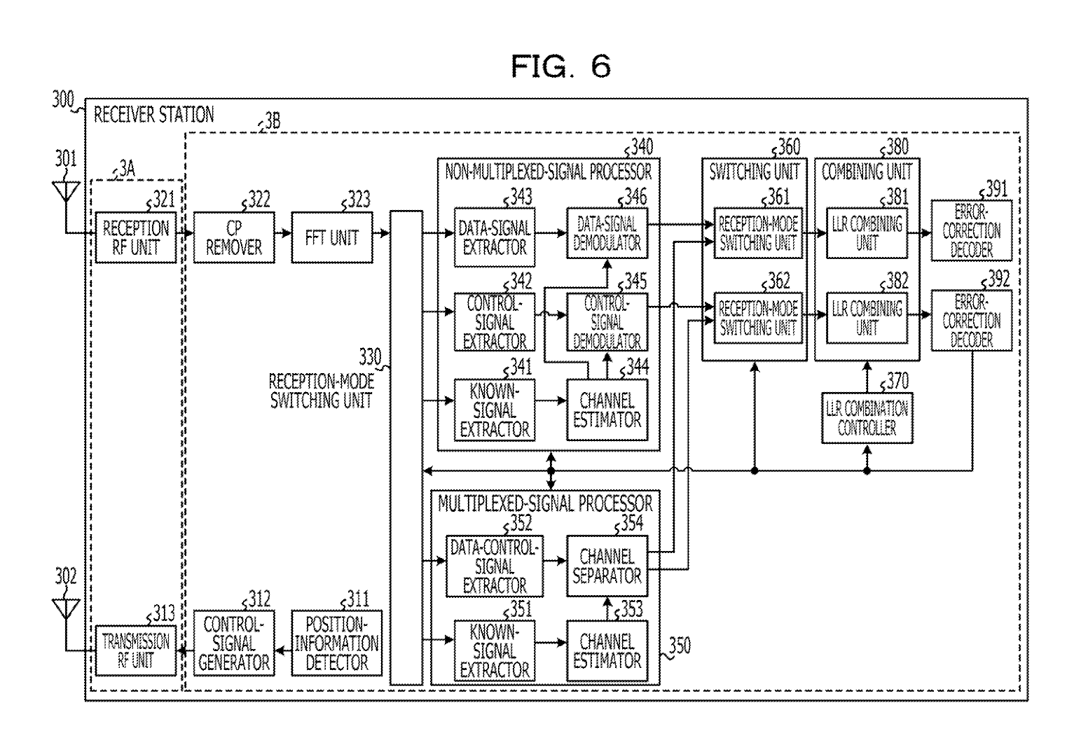

The receiver station 300 in the first embodiment will be described next with reference to FIG. 6. FIG. 6 is a block diagram illustrating an example of configuration of the receiver station 300 in the first embodiment. As illustrated in FIG. 6, the receiver station 300 includes antennas 301 and 302, a position-information detector 311, a control-signal generator 312, and a transmission RF unit 313.

The antenna 301 receives a signal transmitted from an external apparatus (not illustrated). For example, the antenna 301 receives a downlink signal transmitted from the transmitter station 100 and the relay station 200. The antenna 302 transmits a signal to an external apparatus (not illustrated). For example, the antenna 302 transmits an uplink signal to the transmitter station 100. The receiver station 300 may have a shared antenna via which transmission and reception are possible, instead of the antennas 301 and 302.

The position-information detector 311 detects the location of the receiver station 300. For example, the position-information detector 311 detects the location of the receiver station 300, for example, by receiving signals transmitted from global positioning system (GPS) satellites. The position-information detector 311 then outputs position information indicating the location of the receiver station 300 to the control-signal generator 312.

The control-signal generator 312 in the first embodiment generates a control signal. More specifically, the control-signal generator 312 generates a control signal containing the receiver station 300 position information detected by the position-information detector 311.

The transmission RF unit 313 performs various types of processing on the control signal generated by the control-signal generator 312. For example, similarly to the transmission RF unit 183 illustrated in FIG. 4, the transmission RF unit 313 performs D/A conversion processing, orthogonal modulation processing, frequency conversion processing, and so on. The transmission RF unit 313 transmits the control signal, obtained by the frequency conversion processing, to the transmitter station 100 via the antenna 302.

The receiver station 300 also performs processing for generating a data signal containing user data and so on and transmitting the data signal containing the user data and so on. A description of the processing for transmitting the data signal containing the user data and so on is omitted in FIG. 6.

As illustrated in FIG. 6, the receiver station 300 includes a reception RF unit 321, a CP remover 322, an FFT unit 323, and a reception-mode switching unit 330. The reception RF unit 321 performs various types of processing on the signal received by the antenna 301. For example, similarly to the reception RF unit 111 illustrated in FIG. 4, the reception RF unit 321 performs frequency conversion processing, orthogonal demodulation processing, A/D conversion processing, and so on.

The CP remover 322 removes the CP from the signal output from the reception RF unit 321. The FFT unit 323 performs FFT processing on a signal, output from the CP remover 322, to generate a frequency-domain signal.

The reception-mode switching unit 330 receives control data from an error-correction decoder 392 (described below). Based on relay-station-user information contained in the control data, the reception-mode switching unit 330 determines whether or not the receiver station 300, which is the local station, is the relay-station user. When the local station is not the relay-station user, the reception-mode switching unit 330 outputs the signal, input from the FFT unit 323, to a non-multiplexed-signal processor 340 (described below). On the other hand, when the local station is the relay-station user, the reception-mode switching unit 330 outputs the signal, input from the FFT unit 323, to a multiplexed-signal processor 350 (described below).

As illustrated in FIG. 6, the receiver station 300 includes, in addition to the non-multiplexed-signal processor 340 and the multiplexed-signal processor 350, a switching unit 360, an LLR combination controller 370, a combining unit 380, and error-correction decoders 391 and 392.

When the local station is not the relay-station user, the non-multiplexed-signal processor 340 performs various types of processing on the frequency-domain signal input from the reception-mode switching unit 330. The non-multiplexed-signal processor 340 includes a known-signal extractor 341, a control-signal extractor 342, a data-signal extractor 343, a channel estimator 344, a control-signal demodulator 345, and a data-signal demodulator 346.

Based on the resource-assignment information input from the error-correction decoder 392, the known-signal extractor 341 extracts the known signal from the signal input from the reception-mode switching unit 330. Based on the resource-assignment information input from the error-correction decoder 392, the control-signal extractor 342 extracts the control signal from the signal input from the reception-mode switching unit 330. Based on the resource-assignment information input from the error-correction decoder 392, the data-signal extractor 343 extracts the user-data signal from the signal input from the reception-mode switching unit 330.

The channel estimator 344 performs channel estimation processing based on the known signal extracted by the known-signal extractor 341. More specifically, the channel estimator 344 estimates a wireless channel state by determining the correlation between the known signal extracted by the known-signal extractor 341 and the signal known to the receiver station 300.

Based on a result of the channel estimation processing performed by the channel estimator 344, the control-signal demodulator 345 performs channel compensation and demodulation processing on the control signal extracted by the control-signal extractor 342. Based on a result of the channel estimation processing performed by the channel estimator 344, the data-signal demodulator 346 performs channel compensation and demodulation processing on the user-data signal extracted by the data-signal extractor 343.

When the local station is the relay-station user, the multiplexed-signal processor 350 performs various types of processing on the frequency-domain signal input from the reception-mode switching unit 330. The multiplexed-signal processor 350 includes a known-signal extractor 351, a data-control-signal extractor 352, a channel estimator 353, and a channel separator 354.

Based on the resource-assignment information input from the error-correction decoder 392, the known-signal extractor 351 extracts the known signal from the signal input from the reception-mode switching unit 330. As described above with reference to FIGS. 2 and 3, the relay station 200 assigns the null data to the resource region to which the known signal has been assigned by the transmitter station 100 and the relay station 200 also assigns the known signal to the resource region to which the null data has been assigned by the transmitter station 100. Thus, the known-signal extractor 351 may extract, from the signal in which the transmitter-station signal and the relay signal are spatially multiplexed, the known signals transmitted by the transmitter station 100 and the known signals transmitted by the relay station 200.

Based on the resource-assignment information input from the error-correction decoder 392, the data-control-signal extractor 352 extracts the control signal and the user-data signal from the signal input from the reception-mode switching unit 330. When the local station is the relay-station user, the receiver station 300 may receive a signal in which control signals and user-data signals are spatially multiplexed. For example, in the example illustrated in FIG. 3, when the data signals D11 to D13 are user-data signals and the data signals D21 to D23 are control signals, the receiver station 300 receives a signal in which the control signals and the user-data signals are multiplexed. Thus, the data-control-signal extractor 352 may extract, from the signals input from the reception-mode switching unit 330, only control signals, only user-data signals, or a signal in which control signals and user-data signals are spatially multiplexed.

The channel estimator 353 performs channel estimation processing based on the known signals extracted by the known-signal extractor 351. As described above, the known-signal extractor 351 extracts, from the signal in which the transmitter-station signal and the relay signal are spatially multiplexed, the known signals transmitted by the transmitter station 100 and the known signals transmitted by the relay station 200. Thus, upon receiving the signal in which the transmitter-station signal and the relay signal are multiplexed, the channel estimator 353 may perform independent channel estimation processing on both the path of the transmitter-station signal and the path of the relay signal.

Based on the result of the channel estimation processing performed by the channel estimator 353, the channel separator 354 separates the signal, extracted by the data-control-signal extractor 352, into the transmitter-station signal and the relay signal. More specifically, based on the channel estimation processing that the channel estimator 353 individually performed on the path of the transmitter-station signal and the path of the relay signal, the channel separator 354 separates the signal in which the transmitter-station signal and the relay signal are spatially multiplexed into the transmitter-station signal and the relay signal. For example, the channel separator 354 uses a MIMO channel separation algorithm, such as MMSE (minimum means square error) equalization, to separate the spatially multiplexed signal into the transmitter-station signal and the relay signal. The channel separator 354 further extracts the control signals and the user-data signals from the separated transmitter-station signal and also extracts the control signals and the user-data signals from the separated relay signal. The channel separator 354 then outputs the extracted user-data signals to a reception-mode switching unit 361 and outputs the extracted control signals to a reception-mode switching unit 362.

The switching unit 360 includes the reception-mode switching unit 361 and the reception-mode switching unit 362. The reception-mode switching unit 361 determines whether or not the receiver station 300 that is the local station is the relay-station user, based on the relay-station-user information input from the error-correction decoder 392. When the local station is not the relay-station user, the reception-mode switching unit 361 outputs the user-data signals, input from the data-signal demodulator 346, to an LLR combining unit 381 (described below). On the other hand, when the local station is the relay-station user, the reception-mode switching unit 361 outputs the user-data signals, input from the channel separator 354, to the LLR combining unit 381.

The reception-mode switching unit 362 determines whether or not the receiver station 300 that is the local station is the relay-station user, based on the relay-station-user information input from the error-correction decoder 392. When the local station is not the relay-station user, the reception-mode switching unit 362 outputs the control signals, input from the control-signal demodulator 345, to an LLR combining unit 382. On the other hand, when the local station is the relay-station user, the reception-mode switching unit 362 outputs the control signals, input from the channel separator 354, to the LLR combining unit 382.

Based on the relay-station-user information input from the error-correction decoder 392, the LLR combination controller 370 controls the combination processing performed by the combining unit 380. More specifically, the LLR combination controller 370 determines whether or not the receiver station 300 that is the local station is the relay-station user, based on the relay-station-user information input from the error-correction decoder 392. When the local station is the relay-station user, the LLR combination controller 370 controls the combining unit 380 so that it performs the combination processing. When the local station is not the relay-station user, the LLR combination controller 370 controls the combining unit 380 so that it does not perform the combination processing.

The combining unit 380 includes the LLR combining units 381 and 382. When the LLR combining unit 381 is controlled by the LLR combination controller 370 so as not to perform the combination processing, the LLR combining unit 381 outputs the user-data signals, input from the reception-mode switching unit 361, to the error-correction decoder 391.

On the other hand, when the LLR combining unit 381 is controlled by the LLR combination controller 370 so as to perform the combination processing, the LLR combining unit 381 combines the user-data signals input from the reception-mode switching unit 361. In this case, the LLR combining unit 381 stores, in a predetermined buffer, the same user-data signals input from the reception-mode switching unit 361. For example, after holding all the same user-data signals in the buffer, the LLR combining unit 381 performs LLR combination processing on the user-data signals in the buffer. The LLR combining unit 381 then outputs the user-data signals, obtained by the LLR combination processing, to the error-correction decoder 391.

When the LLR combining unit 382 is controlled by the LLR combination controller 370 so as not to perform the combination processing, the LLR combining unit 382 outputs the control signals, input from the reception-mode switching unit 362, to the error-correction decoder 392. On the other hand, when the LLR combining unit 382 is controlled by the LLR combination controller 370 so as to perform the combination processing, the LLR combining unit 382 receives the same control signals from the reception-mode switching unit 362 and performs the LLR combination processing on the same control signals. The LLR combining unit 382 then outputs the control signals, obtained by the LLR combination processing, to the error-correction decoder 392.

The error-correction decoder 391 performs error-correction decoding processing on the user-data signals output from the LLR combining unit 381. As a result, the error-correction decoder 391 obtains the user data from the user-data signals.

The error-correction decoder 392 performs error-correction decoding processing on the control signals output from the LLR combining unit 382. As a result, the error-correction decoder 392 obtains, from the control signals, the control information containing the resource-assignment information, the relay-station-user information, and so on. The error-correction decoder 392 outputs the various types of information, contained in the control information, to the reception-mode switching unit 330, the non-multiplexed-signal processor 340, the multiplexed-signal processor 350, the switching unit 360, and the LLR combination controller 370.

When the non-multiplexed-signal processor 340 and the multiplexed-signal processor 350 do not operate simultaneously, the control-signal extractor 342, the data-signal extractor 343, and the data-control-signal extractor 352 may be shared as a single unit. The channel estimator 344 and the channel estimator 353 may also be shared as a single unit. For example, for a system aimed for a reduction in the hardware size, the processors may be shared. For a system aimed for a reduction in processing time by using dedicated hardware, the processors do not necessarily have to be shared.

The reception RF unit 321 and the transmission RF unit 313 constitute an RF processor 3A, which may be realized by hardware, for example, an integrated circuit, such as an ASIC or FPGA. The position-information detector 311, the control-signal generator 312, the CP remover 322, the FFT unit 323, the reception-mode switching unit 330, the non-multiplexed-signal processor 340, the multiplexed-signal processor 350, the switching unit 360, the LLR combination controller 370, the combining unit 380, the error-correction decoder 391, and the error-correction decoder 392 are included in a baseband processor 3B, which may be realized by hardware, such as a CPU or MPU. That is, the RF processor 3A and the baseband processor 3B may be realized by pieces of hardware that are different from each other. The baseband processor 3B is one example of a third processor.

### Sequence of Processing performed by Wireless Communication System of First Embodiment

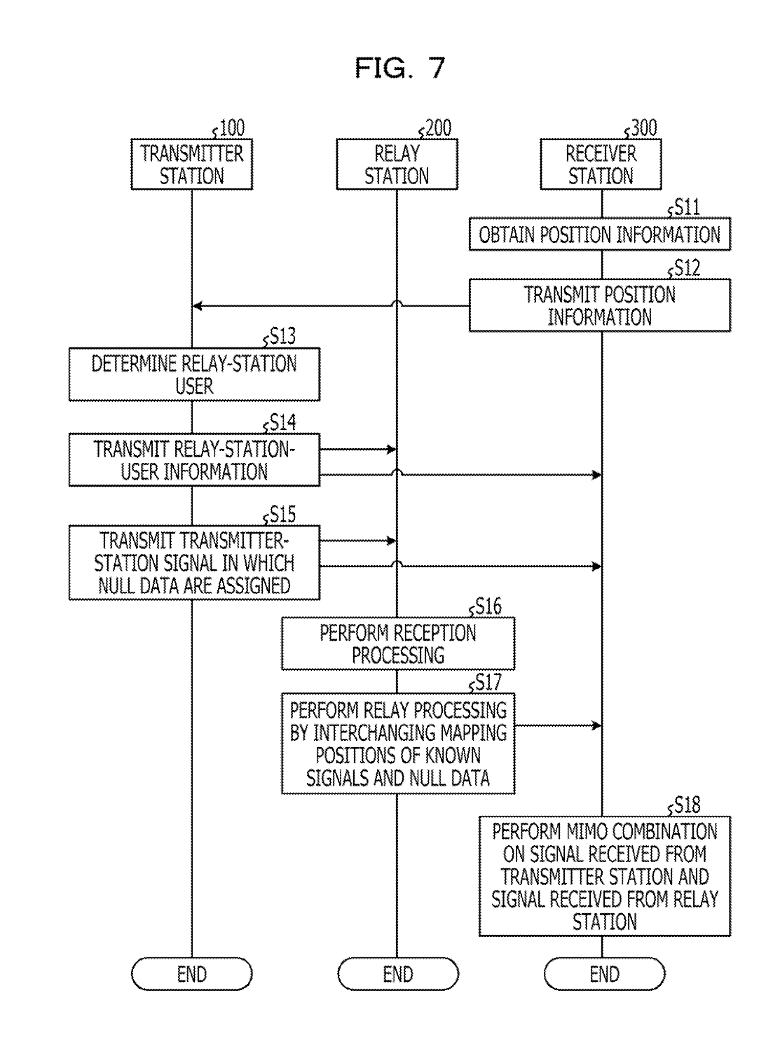

Next, the sequence of processing performed by the wireless communication system 1 according to the first embodiment will be described with reference to FIG. 7. FIG. 7 is a sequence diagram illustrating a procedure of processing performed by the wireless communication system 1 according to the first embodiment. FIG. 7 illustrates a procedure of processing performed by the transmitter station 100, the relay station 200, and the receiver station 300 in the first embodiment.

As illustrated in FIG. 7, in operation S11, the position-information detector 311 in the receiver station 300 obtains position information indicating the location of the receiver station 300. Subsequently, in operation S12, the receiver station 300 transmits the obtained position information to the transmitter station 100. For example, the receiver station 300 transmits a control signal containing the position information to the transmitter station 100.

Subsequently, in operation S13, based on the position information received from the receiver station 300, the relay-station-user selector 120 in the transmitter station 100 determines whether or not the receiver station 300 is to be set as the relay-station user. For example, the relay-station-user selector 120 determines whether or not the receiver station 300 is the relay-station user, based on the distance between the receiver station 300 and the relay station 200. In the example illustrated in FIG. 7, the relay-station-user selector 120 is assumed to set the receiver station 300 as the relay-station user.

In operation S14, the transmitter station 100 transmits, to the relay station 200 and the receiver station 300, relay-station-user information indicating whether or not the receiver station 300 is the relay-station user. For example, the transmitter station 100 transmits, to the relay station 200 and the receiver station 300, a control signal containing resource-assignment information and the relay-station-user information. As a result, the relay station 200 and the receiver station 300 may check whether or not the receiver station 300 is the relay-station user.

In operation S15, the transmitter station 100 generates a transmitter-station signal in which null data are assigned to the resource regions, the number thereof being equal to the number of resource regions to which known signals are assigned, and transmits the generated transmitter-station signal. The relay station 200 and the receiver station 300 receive the transmitter-station signal transmitted by the transmitter station 100.

Upon receiving the transmitter-station signal transmitted by the transmitter station 100, the relay station 200 performs predetermined reception processing in operation S16. The relay station 200 performs, for example, frequency conversion processing, orthogonal demodulation processing, A/D conversion processing, and diffraction-wave elimination processing.

In operation S17, the relay station 200 generates a relay signal by interchanging the mapping positions of the known signals and the null data assigned in the transmitter-station signal received from the transmitter station 100 and then transmits the generated relay signal. In this case, the relay station 200 outputs the generated relay signal with a delay corresponding to the amount of time obtained by subtracting the time taken for the signal processing from the duration of the relay signal.

In operation S18, the receiver station 300 combines the signals transmitted by the transmitter station 100 and the relay station 200. More specifically, by using the known signals transmitted by the transmitter station 100 and the known signals transmitted by the relay station 200, the receiver station 300 performs channel estimation on both the path of the transmitter-station signal and the path of the relay signal. The receiver station 300 then uses the MIMO channel separation algorithm to separate the spatially multiplexed signal into the transmitter-station signal and the relay signal and combines the same control signals and data signals contained in the separated transmitter-station signal and relay signal.

### Other Examples of Transmitter-Station Signal and Relay Signal

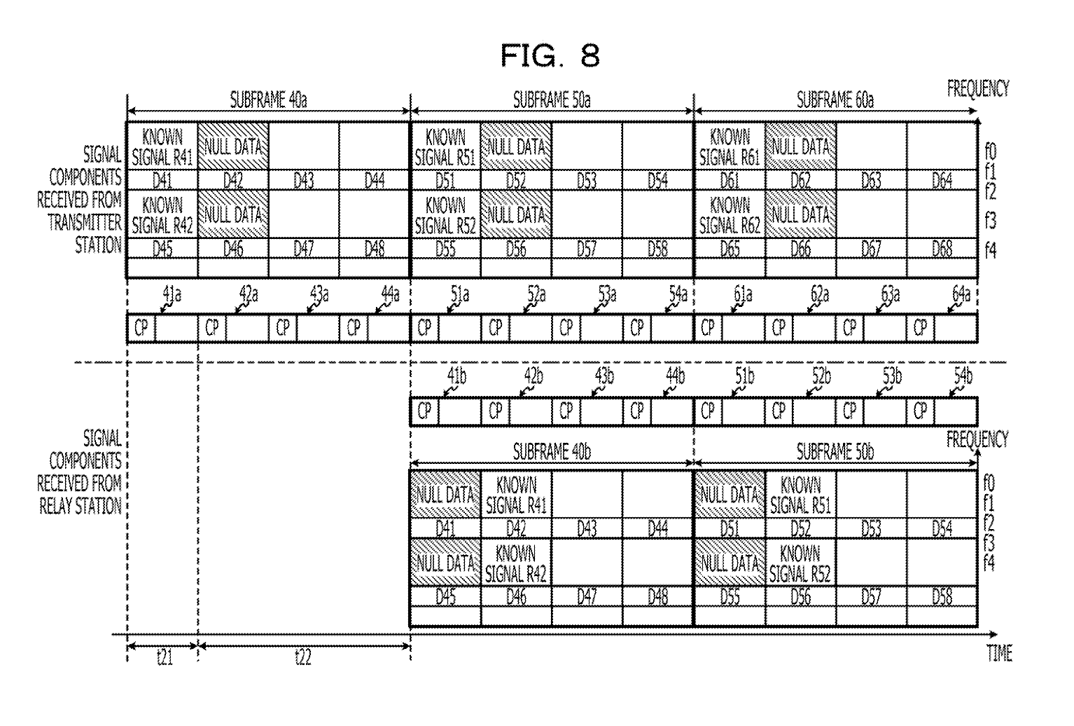

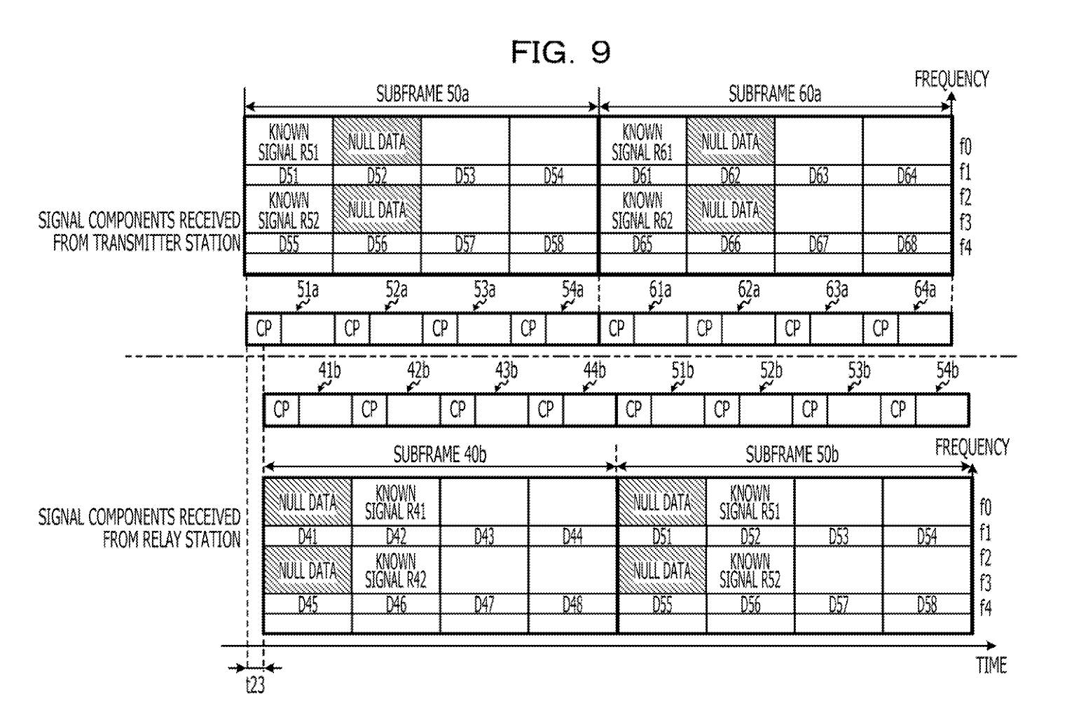

Although an example in which the transmitter station 100 assigns a known signal and null data to each OFDM symbol has been described above, the transmitter station 100 may assign a known signal and null data to each set of two or more OFDM symbols. An example in which a known signal and null data are assigned to each set of OFDM symbols will be described below with reference to FIGS. 8 and 9.

FIG. 8 illustrates examples of signals transmitted/received by the relay station 200 in the first embodiment. The upper stage in FIG. 8 illustrates one example of a transmitter-station signal that the relay station 200 receives from the transmitter station 100. The lower stage in FIG. 8 illustrates one example of a relay signal transmitted by the relay station 200. Time “t21” illustrated in FIG. 8 indicates the amount of time taken for the signal processing performed by the relay station 200.

In the example illustrated in FIG. 8, the transmitter station 100 transmits subframes 40a, 50a, and 60a. Each subframe contains four OFDM symbols. For example, the subframe 40a contains OFDM symbols 41a to 44a, the subframe 50a contains OFDM symbols 51a to 54a, and the subframe 60a contains OFDM symbols 61a to 64a.

In the example illustrated in FIG. 8, the transmitter station 100 assigns null data to, of the OFDM symbols in one subframe, the OFDM symbol adjacent to the OFDM symbol to which a known signal is assigned. For example, the transmitter station 100 assigns a known signal R41 to a frequency domain “f0” in the OFDM symbol 41a contained in the subframe 40a and assigns null data to a frequency domain “f0” in the OFDM symbol 42a. For example, the transmitter station 100 assigns a known signal R42 to a frequency domain “f2” in the OFDM symbol 41a contained in the subframe 40a and assigns null data to a frequency domain “f2” in the OFDM symbol 42a. Similarly, with respect to each of the subframes 50a and 60a, the transmitter station 100 assigns known signals and null data to respective different OFDM symbols in the same subframe.

Upon receiving the subframes 40a, 50a, and 60a illustrated in the upper stage in FIG. 8, the relay station 200 interchanges the mapping positions of the known signals and the null data. That is, in the example illustrated in FIG. 8, the relay station 200 assigns the known signal R41, assigned to the frequency domain “f0” in the OFDM symbol 41a contained in the subframe 40a, to the frequency domain “f0” in the OFDM symbol 42a and also assigns the null data to the frequency domain “f0” in the OFDM symbol 41a. The relay station 200 also assigns the known signal R42, assigned to the frequency domain “f2” in the OFDM symbol 41a, to the frequency domain “f2” in the OFDM symbol 42a and assigns the null data to the frequency domain “f2” in the OFDM symbol 41a.

As a result of the processing, the relay station 200 generates an OFDM symbol 41b from the OFDM symbol 41a and generates an OFDM symbol 42b from the OFDM symbol 42a. The relay station 200 then generates a subframe 40b containing the OFDM symbols 41b to 44b. Similarly, the relay station 200 generates a subframe 50b from the subframe 50a. The subframe 50b serves as a relay signal.

In the example illustrated in FIG. 8, the OFDM symbols 41b to 44b and the OFDM symbols 51b to 54b correspond to the OFDM symbols 41a to 44a and the OFDM symbols 51a to 54a, respectively. Although not illustrated in FIG. 8, the relay station 200 also performs processing for interchanging the mapping positions of the known signals and the null data in the subframe 60a.

In this case, the relay station 200 transmits the subframes 40b and 50b, which serve as a relay signal, with a delay corresponding to a time “t22” obtained by subtracting the signal processing time “t21” from a subframe duration “t20”. More specifically, in the example illustrated in FIG. 8, since the transmitter station 100 assigns the known signals to each set of four OFDM symbols, the receiver station 300 transmits the subframes 40b and 50b with a delay corresponding to the amount of time obtained by subtracting the time taken for the signal processing from the duration “t20” that is four times the OFDM symbol duration.

Next, signals received by the receiver station 300 when the relay signal illustrated in the lower stage in FIG. 8 is transmitted by the relay station 200 will be described with reference to FIG. 9. FIG. 9 illustrates examples of signals received by the receiver station 300 in the first embodiment. The upper stage in FIG. 9 illustrates signal components that the receiver station 300 receives from the transmitter station 100 and the lower stage in FIG. 9 illustrates signal components that the receiver station 300 receives from the relay station 200. FIG. 9 illustrates only the subframes 50a, 60a, 40b, and 50b illustrated in FIG. 8. Time “t23” illustrated in FIG. 9 indicates a propagation delay difference that occurs since the path of the transmitter-station signal and the path of the relay signal are different from each other.

As illustrated in FIG. 9, the receiver station 300 receives the signal in which the subframes 50a and 60a transmitted by the transmitter station 100 and the subframes 40b and 50b transmitted by the relay station 200 are spatially multiplexed.

In the example illustrated in FIG. 9, in the OFDM symbol in which the OFDM symbols 51a and 41b are spatially multiplexed, the frequency domain “f0” is assigned only the known signal R51 and the frequency domain “f2” is assigned only the known signal R52. Thus, the receiver station 300 may extract the known signals R51 and R52, assigned by the transmitter station 100, from the OFDM symbol in which the OFDM symbols 51a and 41b are spatially multiplexed.

In the OFDM symbol in which the OFDM symbol 52a and the OFDM symbol 42b are spatially multiplexed, only the known signal R41 is assigned to the frequency domain “f0” and only the known signal R42 is assigned to the frequency domain “f2”. Thus, the receiver station 300 may extract the known signals R41 and R42, assigned by the relay station 200, from the OFDM symbol in which the OFDM symbols 52a and 42b are spatially multiplexed.

By using the known signals R51 and R52 extracted as described above, the receiver station 300 performs channel estimation processing on the path of the transmitter-station signal. By using the known signals R41 and R42, the receiver station 300 also performs channel estimation processing on the path of the relay signal. As a result, the receiver station 300 separates the signal in which the subframes 50a and 40b are spatially multiplexed into the transmitter-station signal and the relay signal. Similarly, the receiver station 300 separates the signal in which the subframes 60a and 50b are spatially multiplexed into the transmitter-station signal and the relay signal. The receiver station 300 then combines the same data signals of the data signals contained in the separated transmitter-station signal and relay signal.

In the manner described above, the transmitter station 100 in the first embodiment may generate, for each predetermined number of OFDM symbols, a transmitter-station signal in which a known signal is assigned to one OFDM symbol X of the OFDM symbols and null data is assigned to another OFDM symbol Y thereof, as illustrated in FIGS. 8 and 9. Upon receiving such a transmitter-station signal, the relay station 200 may generate a relay signal in which the known signal assigned to the OFDM symbol X is assigned to the other OFDM symbol Y and null data is assigned to the OFDM symbol X.

### Advantages of First Embodiment

As described above, the transmitter station 100 in the first embodiment transmits a transmitter-station signal in which known signals and null data are assigned and, upon receiving the transmitter-station signal, the relay station 200 in the first embodiment transmits a relay signal in which the mapping positions of the known signals and the null data are interchanged. Thus, upon receiving the spatially multiplexed signal from the transmitter station 100 and the relay station 200, the receiver station 300 may perform reception processing that is similar to reception processing for a MIMO-compliant transmitter station. Hence, the wireless communication system 1 according to the first embodiment may improve the quality of the signal received by the receiver station 300.

In addition, based on the position information of the receiver station 300, the transmitter station 100 in the first embodiment determines whether or not the receiver station 300 is to be set as the relay-station user. Thus, the transmitter station 100 may transmit, to only the receiver station 300 that is the relay-station user, the transmitter-station signal in which corresponding null data are assigned to known signals. As a result, the transmitter station 100 may reduce the processing load and may make effective use of the frequency resources.

### Second Embodiment

The wireless communication system, the relay station, the receiver station, and the wireless communication method disclosed herein may also be implemented in various forms other than the above-described embodiment. Accordingly, a description will now be given of a second embodiment of the wireless communication system, the relay station, the receiver station, and the wireless communication method disclosed herein.

### Mapping Position

The examples described above with reference to FIGS. 2 and 3 have been directed to a case in which the transmitter station 100 maps a known signal and null data for each OFDM symbol. That is, in the example illustrated in FIGS. 2 and 3, the transmitter station 100 maps, for each same time domain, the known signal and the null data to respective different frequency domains. In contrast, in the examples illustrated in FIGS. 8 and 9, the transmitter station 100 maps, for each set of at least two or more OFDM symbols, the known signal and the null data to the same frequency domain of the different OFDM symbols.

In the example illustrated in FIGS. 8 and 9, the transmitter station 100 may map a known signal and null data to different frequency domains in different OFDM symbols. For example, the transmitter station 100 may assign a known signal to a frequency domain “f0” in the OFDM symbol located at the beginning of a subframe and assign null data to a frequency domain “f1” in another OFDM symbol in the same subframe.

### System Configuration, Etc.

The elements of the illustrated apparatuses/devices are merely functionally conceptual and do not necessarily have to be physically configured as illustrated. That is, specific forms of separation/integration of the apparatuses/devices are not limited to those illustrated, and all or a portion thereof may be functionally or physically separated or integrated in an arbitrary manner, depending on various types of load, a use state, and so on. For example, the non-multiplexed-signal processor 340 and the multiplexed-signal processor 350 illustrated in FIG. 6 may be integrated together.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system comprising:
a transmitter station that includes
a first processor that generates a first signal in which known data is assigned to a first region determined by a combination of a frequency domain and a time domain, and
a first transmitter that transmits the first signal generated by the first processor;
a relay station that includes
a second processor that generates a second signal in which the known data is assigned to a second region that is different from the first region in the first signal transmitted by the first transmitter, and
a second transmitter that transmits the second signal generated by the second processor; and
a receiver station that includes
a receiver that receives the first and second signals, and
a third processor that separates the first and second signals received by the receiver, based on the known data assigned to the first region and the known data assigned to the second region.

2. The wireless communication system according to claim 1, wherein the second processor outputs the second signal to the second transmitter with a delay corresponding to a predetermined amount of time according to the signal processing performed by the second processor.

3. The wireless communication system according to claim 1, wherein the first processor generates the first signal by assigning the known data to the first region and assigning predetermined data to the second region; and
the second processor generates the second signal by assigning the known data, contained in the first region in the first signal, to the second region and assigning the predetermined data to the first region.

4. The wireless communication system according to claim 1, wherein the first processor generates the first signal by assigning, for each time domain, the known data and predetermined data to the first region and the second region, respectively; and
the second processor generates the second signal by assigning the known data, contained in the first region in the first signal, to the second region and assigning the predetermined data to the first region.

5. The wireless communication system according to claim 1, wherein the transmitter station further comprises a determining unit that determines, based on position information indicating a location of the receiver station, whether or not the receiver station is to be set as a relay-station user serving as a receiver station for receiving the signal transmitted by the second transmitter in the relay station;
the first processor generates the first signal in which the known data is assigned to the first region, only with respect to the signal to be transmitted to the receiver station determined to be set as the relay-station user by the determining unit; and
the second processor generates the second signal, only with respect to the first signal transmitted by the transmitting unit and destined for the receiver station determined to be set as the relay-station user by the determining unit.

6. A relay station comprising:
a receiver that receives, from a transmitter station, a signal in which known data used for propagation path estimation is assigned to a first region determined by a combination of a frequency domain and a time domain and predetermined data is assigned to a second region that is different from the first region;
a processor that performs processing for generating a signal in which the known data is assigned to the second region in the signal received by the receiver; and
a transmitter that transmits the signal generated by the processor.

7. A receiver station comprising:
a receiver that receives, from a transmitter station, a first signal in which known data used for propagation channel estimation is assigned to a first region determined by a combination of a frequency domain and a time domain and that receives, from a relay station, a second signal in which the predetermined data is assigned to the first region and the known data is assigned to the second region; and
a processor that separates the first and the second signals received by the receiver, based on the known data assigned to the first region and the known data assigned to the second region, and combines same signals contained in the first signal and the separated second signal.

8. A wireless communication method for a wireless communication system in which a transmitter station and a receiver station are capable of performing wireless communication via a relay station, the wireless communication method comprising:
generating, at the transmitter station, a first signal in which known data is assigned to a first region determined by a combination of a frequency domain and a time domain;
transmitting, at the transmitter station, the first signal;
generating, at the relay station, a second signal in which the known data is assigned to a second region that is different from the first region in the first signal;
transmitting, at the relay station, the second signal;
receiving, at the receiver station, the first and second signals, and
separating, at the receiver station, the received first and second signals, based on the known data assigned to the first region and the known data assigned to the second region.
